(19) United States
(12) Patent Application Publication
(10) Pub. No.: US 2024/0069159 A1
(43) Pub. Date: Feb. 29, 2024

(54) RADAR INSTALLATION-ANGLE ADJUSTMENT METHOD

(71) Applicant: Sumitomo Electric Industries, Ltd., Osaka-shi, Osaka (JP)

(72) Inventor: Hideaki SHIRANAGA, Osaka-shi, Osaka (JP)

(73) Assignee: Sumitomo Electric Industries, Ltd., Osaka-shi, Osaka (JP)

(21) Appl. No.: 18/272,098

(22) PCT Filed: Nov. 16, 2021
(86) PCT No.: PCT/JP2021/042109

§ 371 Date: Jul. 13, 2023

(30) Foreign Application Priority Data
Jan. 15, 2021 (JP) 2021-004844

(51) Int. Cl. G01S 7/40

(52) U.S. Cl. CPC G01S 7/40

(57) ABSTRACT

The installation angle of a radar for traffic monitoring can be easily adjusted. A radar installation-angle adjustment method is a radar installation-angle adjustment method of adjusting an installation angle of an infrastructure radio-wave radar configured to detect an object in a target area. The method includes first adjustment of adjusting an angle of a radar installed at an installation target without operating the radar; and second adjustment of operating the radar the angle of which has been adjusted in the first adjustment, and adjusting the angle of the radar based on a detection result of the radar.

### TECHNICAL FIELD

The present disclosure relates to a radar installation-angle adjustment method. This application claims priority based on Japanese Patent Application No. 2021-004844 filed on Jan. 15, 2021, the entire contents of which are incorporated herein by reference.

### BACKGROUND

PTL 1 discloses an axis adjustment device for performing axis adjustment of a vehicle-mounted radar mounted on a vehicle.

### PRIOR ART DOCUMENT

### Patent Literature

PTL 1: Japanese Unexamined Patent Application Publication No. 2015-68746

### SUMMARY

A radar installation-angle adjustment method according to an embodiment of the present disclosure is a radar installation-angle adjustment method of adjusting an installation angle of a radar configured to detect an object in a target area. The method includes first adjustment of adjusting an angle of a radar installed at an installation target without operating the radar; and second adjustment of operating the radar the angle of which has been adjusted in the first adjustment, and adjusting the angle of the radar based on a detection result of the radar.

The present disclosure can be implemented not only as a radar installation-angle adjustment method including the characteristic steps as described above, but also as a radar for use in the radar installation-angle adjustment method, or as a computer program for causing a computer to perform a part of the method.

### BRIEF DESCRIPTION OF THE DRAWINGS

FIG. 1 is a diagram showing an example of the use of a radar according to an embodiment.

FIG. 2 is a perspective view showing an example of an appearance configuration of a radar according to the embodiment.

FIG. 3 is a flowchart showing an example of a radar installation-angle adjustment method according to the embodiment.

FIG. 4A is a perspective view showing another example of an appearance configuration of a radar according to the embodiment.

FIG. 4B is a perspective view showing another example of the appearance configuration of the radar according to the embodiment.

FIG. 4C is a perspective view showing another example of the appearance configuration of the radar according to the embodiment.

FIG. 5 is an example of a field of view of a sighting device.

FIG. 6 is a block diagram showing a connection relationship between devices when an information terminal is used in a first adjustment.

FIG. 7 is a block diagram showing a connection relationship between devices when an information terminal is used in a second adjustment.

FIG. 8A is a diagram showing a display example of a traveling track of a vehicle.

FIG. 8B is a diagram showing a display example of a traveling track of a vehicle.

FIG. 9 is a diagram showing a display example of the number of vehicles for each lane.

### DETAILED DESCRIPTION

### Problem to be Solved by Present Disclosure

Radar is also used for traffic monitoring at intersections, roads, etc. A traffic monitoring radar (hereinafter, also referred to as an “infrastructure radio-wave radar”) is installed at an intersection or a road by an installer, and an angle of the installed radar is adjusted by an adjuster. At the time of installation by the installer, adjustment by the installer is difficult because the power supply is not connected to the radar and the installer has no knowledge of the angle adjustment of the radar. The power of the installed radar is turned on in the adjustment stage, and the adjuster adjusts the angle so that the irradiation axis is directed in an appropriate direction while checking the output. However, since the radar installed by the installer has various angles and the optimum angle varies depending on the installation position, the radar needs to be removed once and installed again in some cases in order to correctly adjust the radar, and the adjustment is complicated.

### Effects of Present Disclosure

According to the present disclosure, the installation angle of a radar for traffic monitoring can be easily adjusted.

### Overview of Embodiments of Present Disclosure

The following lists and describes an overview of embodiments of the present disclosure.

(1) A radar installation method according to an embodiment of the present disclosure is a radar installation-angle adjustment method of adjusting an installation angle of an infrastructure radio-wave radar configured to detect an object in a target area. The method includes first adjustment of adjusting an angle of a radar installed at an installation target without operating the radar; and second adjustment of operating the radar the angle of which has been adjusted in the first adjustment, and adjusting the angle of the radar based on a detection result of the radar. Thus, in the first adjustment, the angle of the radar can be adjusted even when the power supply of the radar is not turned on. Therefore, since the installer in charge of the installation work of the radar can perform the first adjustment, the installation angle of the radar can be easily adjusted. It should be noted that the term “operate” as used herein refers to causing the radar to perform a function of detecting an object. That is, even if an accessory part attached to the radar, for example, an angle check unit or the like to be described later is in an operable state, the radar is in a non-operating state unless a function of detecting an object by the radar is exhibited.

(2) The first adjustment may include determining whether a check result of an angle check unit attached to the radar satisfies a first condition set in advance, and the first adjustment may be completed when the check result satisfies the first condition. Accordingly, the execution entity of the first adjustment can easily determine the completion of the first adjustment. Therefore, even an installer who does not have knowledge about the adjustment of the radar can easily perform the first adjustment.

(3) The angle check unit may be a sighting device, and the first condition may be that a field of view of the sighting device is included in the target area. The completion of the first adjustment can be easily determined with the sighting device.

(4) The angle check unit may be an angle sensor configured to detect at least one angle of a horizontal angle and a depression angle of the radar, and the first condition may be that the angle detected by the angle sensor is included in a predetermined setting range. Thus, by comparing the angle detected by the angle sensor with the setting range, it is possible to clearly determine whether the first condition is satisfied. Therefore, the completion of the first adjustment can be easily determined.

(5) The first adjustment may include determining the setting range based on the angle detected by the angle sensor and an installation height of the radar. This makes it possible to determine an appropriate setting range in accordance with the angle detected by the angle sensor and the installation height of the radar.

(6) The setting range may be determined by an information terminal configured to receive angle information indicating the angle detected by the angle sensor and height information indicating the installation height. Thus, the setting range can be easily determined by the information terminal.

(7) The angle check unit may be attachable to and detachable from the radar, and the angle check unit may be attached to the radar in the first adjustment. Accordingly, the angle check unit can be attached to the radar only when the first adjustment is performed.

(8) The second adjustment may include determining whether the detection result of the radar satisfies a second condition set in advance, and the second adjustment may be completed when the detection result satisfies the second condition. Accordingly, the execution entity of the second adjustment can easily determine the completion of the second adjustment.

(9) The second condition may be that a position of an object detected by the radar is included in a predetermined range. Accordingly, it is possible to clearly determine whether the second condition is satisfied based on the position of the object detected by the radar.

(10) The second condition may be that a difference between the number of objects detected by the radar and the number of objects in the target area is included in a predetermined setting range. Accordingly, it is possible to clearly determine whether the second condition is satisfied based on the number of objects detected by the radar.

### Details of Embodiments of Present Disclosure

Hereinafter, embodiments of the present invention will be described in detail with reference to the drawings. At least a part of the embodiments described below may be arbitrarily combined.

[1. Radar]

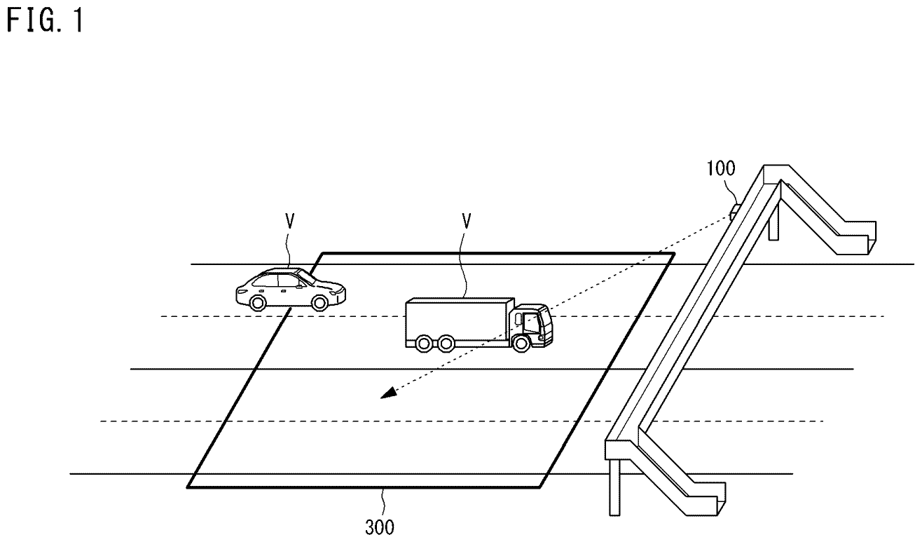

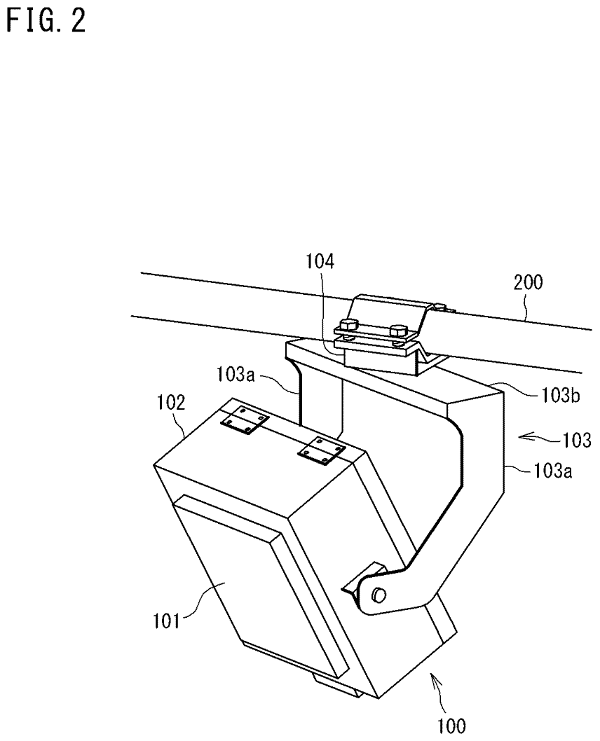

FIG. 1 is a diagram showing an example of the use of a radar according to an embodiment. A radar 100 according to the embodiment of the present disclosure is a radio-wave radar (an infrastructure radio-wave radar) for traffic monitoring. Radar 100 is attached to an arm 200 (see FIG. 2) or the like provided at an intersection or on a road. Radar 100 is a millimeter wave radar, and is a radio wave sensor. Radar 100 irradiates a target area 300 on a road with radio waves (millimeter waves) and receives the reflected waves to detect an object (for example, a vehicle V) in target area 300. More specifically, radar 100 can detect a distance to vehicle V traveling on the road, a speed of vehicle V, and a horizontal angle of a position where vehicle V exists with respect to a radio wave irradiation axis of the radar.

Radar 100 is installed so that the direction of the radio wave irradiation axis (the method indicated by the dashed line in FIG. 1. Hereinafter, it is referred to as a “reference direction”.) faces target area 300. If the reference direction does not correctly face target area 300, radar 100 cannot correctly detect an object in target area 300. Therefore, in the embodiment of the present disclosure, the angle of radar 100 is adjusted so that the reference direction faces target area 300 by a radar installation-angle adjustment method as described below.

FIG. 2 is a perspective view of an exemplary exterior configuration of radar 100 according to the embodiment of the present disclosure. As shown in FIG. 2, radar 100 includes a transmitting/receiving surface 101 for transmitting and receiving millimeter waves. The reference direction is the normal direction of transmitting/receiving surface 101. Radar 100 includes at least one transmitting antenna (not shown) and a plurality of (for example, two) receiving antennas (not shown). Radar 100 transmits a modulated wave which is a millimeter wave from a transmitting antenna through transmitting/receiving surface 101. The modulated wave hits an object and is reflected, and the receiving antenna receives the reflected wave. Radar 100 performs signal processing on the transmission wave signal and the reception wave signal by a signal processing circuit (not shown), and detects a distance to an object, an angle at which the object exists (hereinafter referred to as “object position”), and a speed of the object.

Radar 100 is configured to be capable of adjusting an installation angle. Radar 100 includes a radar body 102, a depression angle adjustment unit 103, and a horizontal angle adjustment unit 104. Radar body 102 is formed in a box shape, and depression angle adjustment unit 103 is attached to a side surface of radar body 102. Depression angle adjustment unit 103 may include a pair of arms 103a and a coupling portion 103b connecting the pair of arms 103a. Each of the pair of arms 103a is rotatable around a horizontal axis parallel to transmitting/receiving surface 101 on both side surfaces of radar body 102. Radar body 102 can be rotated around a horizontal axis by depression angle adjustment unit 103, and thus the depression angle of radar body 102 is adjusted.

Coupling portion 103b is connected to horizontal angle adjustment unit 104. Horizontal angle adjustment unit 104 is fixed to a pole which is an installation target. Horizontal angle adjustment unit 104 is rotatable around a vertical axis on the upper surface of coupling portion 103b. Radar body 102 connected to horizontal angle adjustment unit 104 through depression angle adjustment unit 103 can be rotated around the vertical axis by horizontal angle adjustment unit 104, thereby adjusting the horizontal angle of radar body 102.

[2. Radar Installation-Angle Adjustment Method]

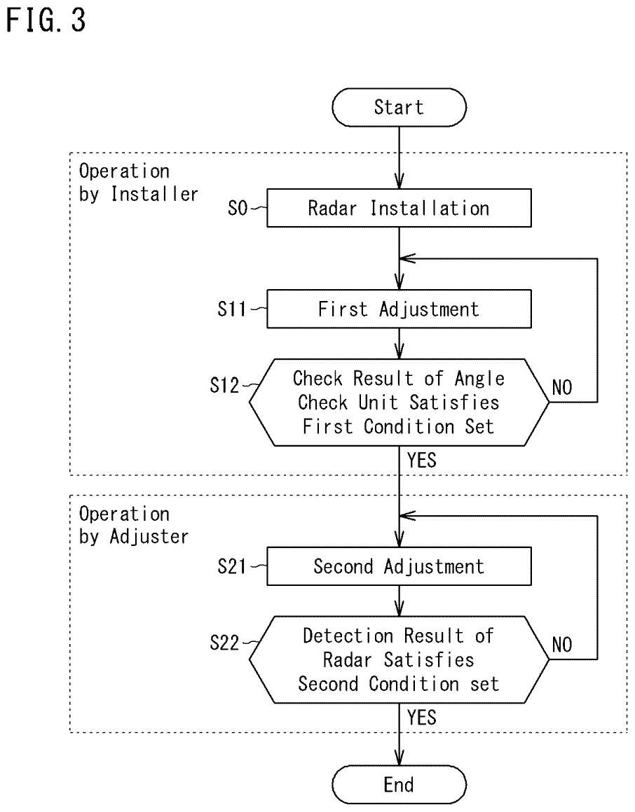

FIG. 3 is a flowchart showing an example of a radar installation-angle adjustment method according to the embodiment of the present disclosure.

First, an installer installs radar 100 on an installation target (pole) (step S0). At this time, radar 100 is not connected to a power supply.

Next, the first adjustment is performed (step S11). In the first adjustment, radar 100 is not operated and the angle of radar 100 is adjusted.

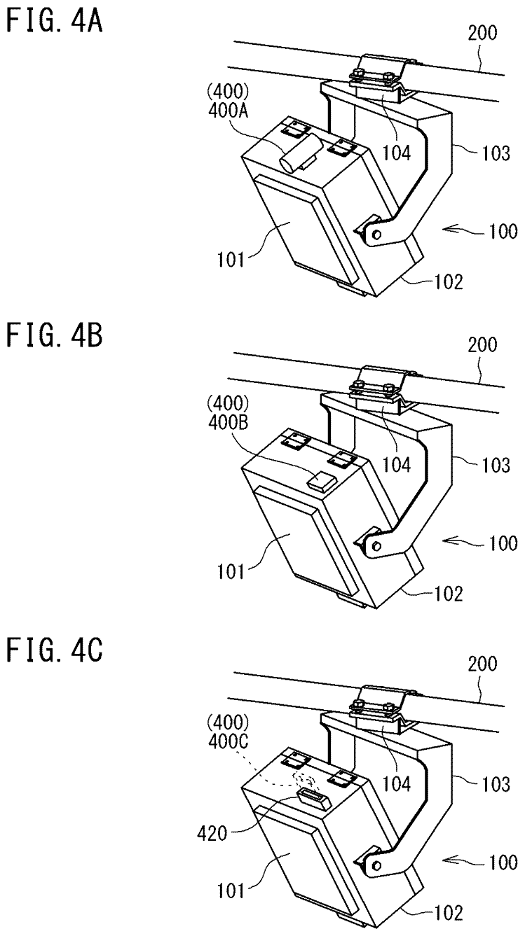

For example, radar 100 is provided with an angle check unit 400. In the first adjustment, angle check unit 400 may be used. FIGS. 4A to 4C shows examples of angle check units 400 according to the embodiment of the present disclosure.

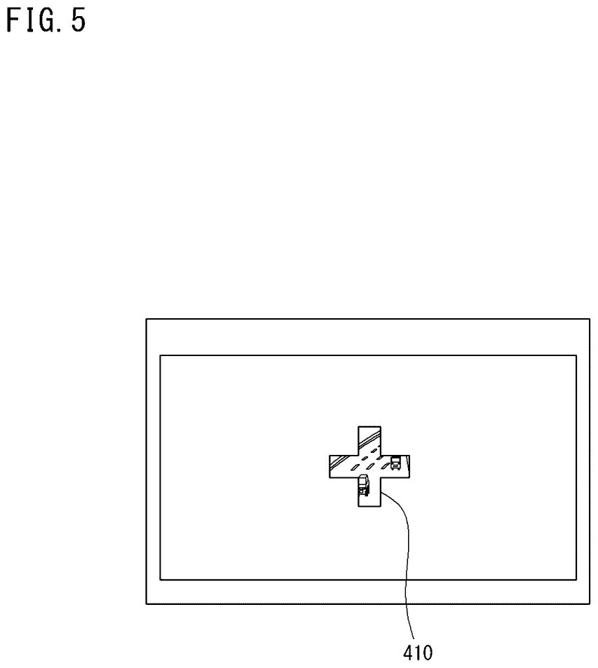

In the example of FIG. 4A, angle check unit 400 is a sighting device 400A. Sighting device 400A is fixed to radar body 102 such that the optical axis (the central axis of the sighting device) is parallel to the reference direction of radar 100. The user (for example, an installer) performs the first adjustment while checking the field of view of sighting device 400A. FIG. 5 is an example of a field of view of sighting device 400A. In the example of FIG. 5, sighting device 400A is provided with a slit 410, and slit 410 is the field of view of sighting device 400A.

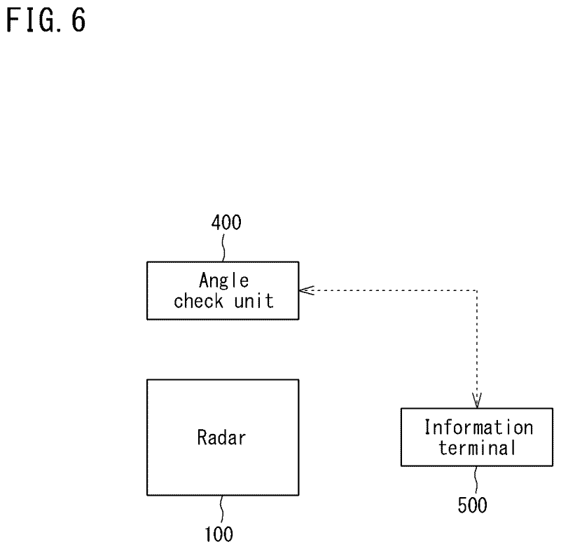

In the first adjustment, an information terminal may be used. FIG. 6 is a block diagram showing a connection relationship between devices when an information terminal is used in the first adjustment. Angle check unit 400 is connected to an information terminal 500 in a wired manner or a wireless manner, and transmits data of a check result to information terminal 500. Information terminal 500 is, for example, a smartphone, a tablet, or a laptop computer. When angle check unit 400 is sighting device 400A, sighting device 400A may include an image sensor and be capable of outputting a field of view image of sighting device 400A. For example, the field of view image of sighting device 400A is displayed on the display of information terminal 500. The user can adjust the angle of radar 100 while checking the field of view image displayed on the display of information terminal 500. Accordingly, when the installation position of radar 100 is a position where the user cannot look into sighting device 400A, the user can check the field of view of sighting device 400A on the display of information terminal 500.

In the example of FIG. 4B, angle check unit 400 is an angle sensor 400B. Angle sensor 400B can detect, for example, a horizontal angle and a vertical angle (depression angle). As shown in FIG. 6, angle sensor 400B is connected to information terminal 500. Data of a detection value (angle) of angle sensor 400B is transmitted to information terminal 500. For example, information terminal 500 can display the horizontal angle and the depression angle detected by angle sensor 400B on a display. Further, the display of information terminal 500 may display an appropriate horizontal angle and an appropriate depression angle of radar 100 or may display an appropriate range of the horizontal angle and an appropriate range of the depression angle. The user can adjust the angle of radar 100 while checking the horizontal angle and depression angle detected by angle sensor 400B and displayed on the display of information terminal 500. The user can easily adjust an appropriate horizontal angle and an appropriate depression angle by adjusting the angle of radar 100 while comparing the horizontal angle and the depression angle detected by angle sensor 400B with an appropriate horizontal angle and an appropriate depression angle or an appropriate range of the horizontal angle and an appropriate range of the depression angle.

An installation height (height from the ground) of radar 100 may be input to information terminal 500, and information terminal 500 may determine the appropriate range of the depression angle based on the installation height. The appropriate depression angle of radar 100 varies depending on the installation height of the radar. Therefore, an appropriate range of the depression angle according to the installation height of radar 100 is appropriately set.

Angle check unit 400 may be attachable to and detachable from radar body 102. For example, an attachment portion for attaching and detaching angle check unit 400 is provided in radar body 102, and by attaching angle check unit 400 to the attachment portion, angle check unit 400 is attached at an appropriate angle with respect to radar body 102. For example, angle check unit 400 may be attached to radar 100 when the first adjustment is performed, and may be detached from radar 100 when the first adjustment is completed.

In the example of FIG. 4C, a smartphone 400C having a function as angle check unit 400 is attached to radar body 102. Radar body 102 is provided with a fixing portion 420 for fixing smartphone 400C. Smartphone 400C can be attached to and detached from fixing portion 420. The built-in camera of smartphone 400C may be used as a sighting device. Further, an angle sensor (a direction sensor and a gyro sensor) built in smartphone 400C can be used.

FIG. 3 is referred again. The user determines whether the result of confirmation by angle check unit 400 satisfies a predetermined first condition (step S12).

When angle check unit 400 is sighting device 400A, the first condition is that the field of view in sighting device 400A is included in (at least a part of) target area 300. For example, one point in target area 300 can be set as the adjustment point, and the first condition can be that the field of view includes the adjustment point. When the adjustment point is included in the field of view of sighting device 400A, the user determines that the first condition is satisfied. When the adjustment point is not included in the field of view of sighting device 400A, the user determines that the first condition is not satisfied.

When angle check unit 400 is angle sensor 400B, the first condition is that the value detected by angle sensor 400B falls within a predetermined setting range. The setting range can be the above-described appropriate range. When the value detected by angle sensor 400B falls within the setting range, the user determines that the first condition is satisfied. When the value detected by angle sensor 400B is out of the setting range, the user determines that the first condition is not satisfied.

When the check result of angle check unit 400 does not satisfy the first condition (NO in step S12), it is determined that the first adjustment has not been completed. In this case, the process returns to step S11 and the first adjustment is continued.

When the check result of angle check unit 400 satisfies the first condition (YES in step S12), it is determined that the first adjustment is completed. In this case, the process proceeds to next step S21.

First adjustment step S11 and step S12 as above described may be performed by an installer when radar 100 is installed in an installation target. By the first adjustment as described above, even an installer who does not have knowledge about the angle adjustment of the radar can easily adjust the angle of radar 100. Further, since the angle of radar 100 is generally appropriately adjusted in the first adjustment, in the subsequent second adjustment, it is only necessary for the adjuster to finely adjust the angle of radar 100, and the burden of adjustment operation is reduced.

Next, the second adjustment is performed (step S21). The second adjustment is performed in the angle adjustment operation of radar 100 by the adjuster. In the angle adjustment operation, power is supplied to radar 100. In the second adjustment, radar 100 is operated, and the angle of radar 100 is adjusted based on the detection result of radar 100.

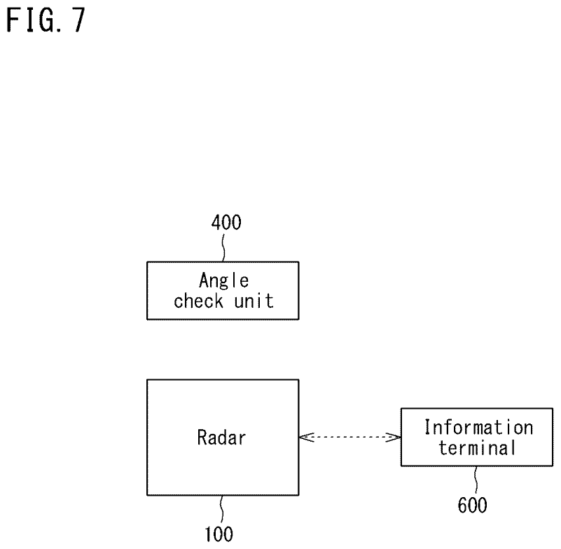

In the second adjustment, an information terminal may be used. FIG. 7 is a block diagram showing a connection relationship between devices when an information terminal is used in the second adjustment. Radar 100 is connected to an information terminal 600 in a wired manner or a wireless manner and transmits data of a detection result to information terminal 600. Information terminal 600 is, for example, a smartphone, a tablet, or a laptop computer.

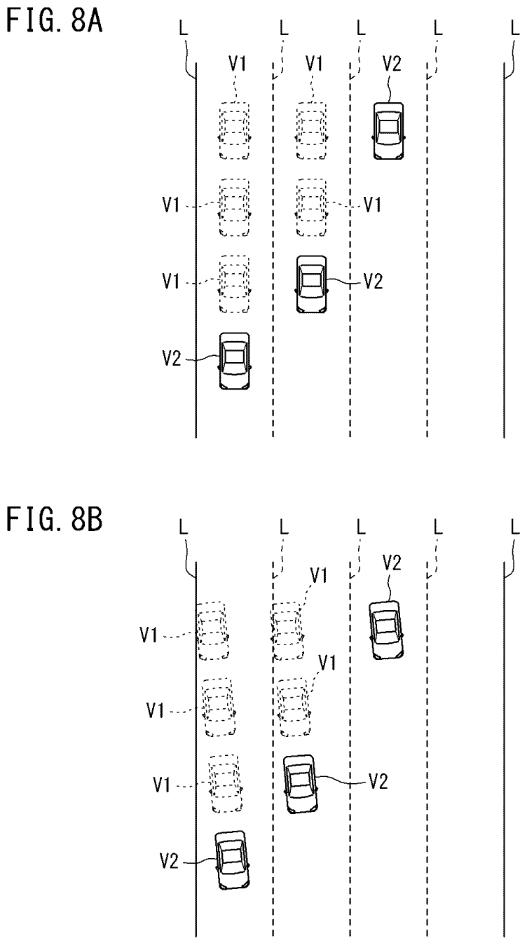

The detection result of radar 100 is displayed on the display of information terminal 600. For example, information terminal 600 may process the detection data of radar 100 and display the traveling track of the detected vehicle on the screen. FIGS. 8A and 8B are diagrams showing display examples of the traveling track of the vehicle. As shown in FIGS. 8A and 8B, a lane boundary line L is included in the screen, and a lane is represented. Further, the detected traveling track of vehicle V is displayed on the screen. In the figure, a figure V1 of the vehicle on the dashed line indicates the position of the vehicle detected in the past, and a figure V2 of the vehicle on the solid line indicates the latest position of the vehicle. Since the time-series positions of the vehicle are displayed, the traveling track of the vehicle is shown.

By checking the screen, the user can determine whether the position of the detected vehicle is included in the predetermined range. In one specific example, the user can determine whether the track of the detected vehicle is within a lane. FIG. 8A shows a case where the track of the detected vehicle is included in the lane. In this case, it can be determined that radar 100 is adjusted to an appropriate angle. FIG. 8B shows a case where the track of the detected vehicle deviates from the lane. When the track of the vehicle deviates from the lane even though the vehicle does not change lanes, it can be determined that radar 10 is not adjusted to an appropriate angle. The user can adjust the angle of radar 100 while checking the track of the vehicle displayed on the display of information terminal 600.

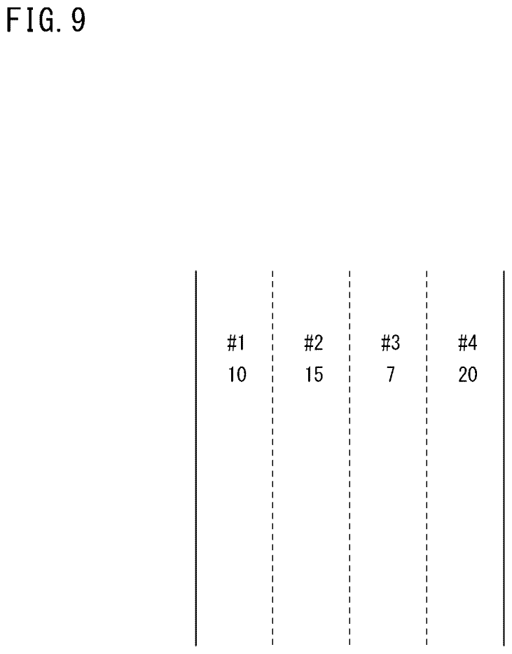

For example, information terminal 600 may process the detection data of radar 100 and display the number of detected vehicles for each lane on the screen. FIG. 9 is a diagram showing a display example of the number of vehicles for each lane. In the example of FIG. 9, the number of vehicles (10, 15, 7, 20) is displayed in association with the lane numbers (#1, #2, #3, #4). The user visually counts the number of vehicles for each lane and compares it with the number of vehicles for each lane displayed on the screen. When the visually checked number of vehicles for each lane matches the number of vehicles for each lane displayed on the screen, it can be determined that radar 100 is adjusted to an appropriate angle. When the visually checked number of vehicles for each lane does not match the number of vehicles for each lane displayed on the screen, it can be determined that radar 100 is not adjusted to an appropriate angle. The user can adjust the angle of radar 100 while checking the number of vehicles displayed on the display of information terminal 600.

FIG. 3 is referred again. The user determines whether the detection result of radar 100 satisfies a predetermined second condition (step S22).

For example, the second condition is that a position of a detected vehicle is included in a predetermined range. In the example shown in FIGS. 8A and 8B, the second condition is that the track of the detected vehicle is included in the lane. When the detected track of the vehicle is included in the lane, the user determines that the second condition is satisfied. When the detected track of the vehicle deviates from the lane even though the vehicle does not change lanes, the user determines that the second condition is not satisfied.

For example, the second condition is that a difference between the number of detected vehicles and the number of vehicles in target area 300 is included in the predetermined setting range. In the examples shown in FIG. 9, the second condition is that the difference between the number of detected vehicles for each lane and the number of vehicles for each lane visually checked by the user is included in the setting range. When the difference between the detected number of vehicles for each lane and the visually checked number of vehicles for each lane is included in the setting range, the user determines that the second condition is satisfied. When the difference between the detected number of vehicles for each lane and the visually checked number of vehicles for each lane is not included in the setting range, the user determines that the second condition is not satisfied. It is preferable that the setting range is a range including a certain range such as 0 to 5 vehicles. Accordingly, when it is difficult to visually count the accurate number of vehicles, for example, when the contrast of the camera is low or the like, allowing an error in counting, it is possible to determine whether the angle of the radar is accurately adjusted.

When the detection result of radar 100 does not satisfy the second condition (NO in step S22), it is determined that the second adjustment has not been completed. In this case, the process returns to step S21 and the second adjustment is continued.

When the detection result of radar 100 satisfies the second condition (YES in step S22), it is determined that the second adjustment is completed. In this case, the adjustment of the installation angle of radar 100 is completed.

[3. Modification]

In the above-described embodiment, step S12 of determining whether the check result of angle check unit 400 satisfies the first condition is performed by the user, but the present invention is not limited thereto. Step S12 may be performed by information terminal 500.

When angle check unit 400 is sighting device 400A, for example, an image of a scene that enters the field of view of sighting device 400A when radar 100 is adjusted to an appropriate angle is stored in advance in information terminal 500 as a standard image. Information terminal 500 can match the field of view image output from sighting device 400A with the standard image, determine that the first condition is satisfied when the degree of similarity between the two images is equal to or more than a predetermined value, and determine that the first condition is not satisfied when the degree of similarity is less than the predetermined value.

When angle check unit 400 is angle sensor 400B, for example, the appropriate range of the horizontal angle and the appropriate range of the depression angle of radar 100 are stored in advance in information terminal 500 as the setting range. Information terminal 500 can compare the detection values of the horizontal angle and the depression angle by angle sensor 400B with the setting range, determine that the first condition is satisfied when the detection values are falls within the setting range, and determine that the first condition is not satisfied when the detection values are out of the setting range.

When angle check unit 400 is smartphone 400C, step S12 may be performed by smartphone 400C.

When angle check unit 400 is connected to a server through a communication network, step S12 may be performed by the server instead of information terminal 500.

In the above-described embodiment, step S22 of determining whether the detection result of radar 100 satisfies the second condition is performed by the user, but the present invention is not limited thereto. Step S22 may be performed by information terminal 600.

For example, information terminal 600 calculates the track of the vehicle for each lane based on the detection data of radar 100, and determines whether the track of the vehicle is included in the lane. When the track of the vehicle is within the lane, it can be determined that the second condition is satisfied, and when the track of the vehicle deviates from the lane, it can be determined that the second condition is not satisfied.

For example, information terminal 600 detects the number of vehicles for each lane based on the detection data of radar 100, detects the number of vehicles for each lane by processing an image obtained by another detection unit, for example, a camera, and determines whether the number of vehicles detected based on the detection data matches the number of vehicles detected by processing the image. When the number of vehicles obtained from the detection data of radar 100 matches the number of vehicles detected by another detection unit, it can be determined that the second condition is satisfied, and when they do not match, it can be determined that the second condition is not satisfied.

When radar 100 is connected to a server through a communication network, step S22 may be performed by the server instead of information terminal 600.

[4. Effects]

As described above, the installation-angle adjustment method of radar 100 according to the embodiment adjusts the installation angle of radar 100, which is an infrastructure radio-wave radar configured to detect vehicle V in target area 300. The installation-angle adjustment method of radar 100 includes first adjustment S11 and second adjustment S21. In first adjustment S11, the angle of radar 100 installed at the installation target is adjusted without operating radar 100. In second adjustment S21, radar 100 the angle of which has been adjusted in the first step is operated, and the angle of radar 100 is adjusted based on the detection result of radar 100. Thus, in first adjustment S11, the angle of radar 100 can be adjusted even when the power supply of radar 100 is not turned on. Therefore, since the installer in charge of the installation work of radar 100 can perform first adjustment S11, the installation angle of radar 100 can be easily adjusted.

First adjustment step S11 may include step S12 of determining whether a check result of angle check unit 400 attached to radar 100 satisfies a first condition set in advance. First adjustment step S11 may be completed, when the check result of angle check unit 400 satisfies the first condition. Accordingly, an execution entity (for example, an installer) of first adjustment S11 can easily determine the completion of first adjustment S11. Therefore, even an installer who does not have knowledge about the adjustment of the radar can easily perform first adjustment S11.

Angle check unit 400 may be sighting device 400A. The first condition may be that the field of view of sighting device 400A is included in target area 3X). The completion of first adjustment S11 can be easily determined with sighting device 400A.

Angle check unit 400 may be angle sensor 400B configured to detect at least one of a horizontal angle and a depression angle of radar 100. The first condition may be that the angle detected by angle sensor 400B is included in the predetermined setting range. Thus, by comparing the angle detected by angle sensor 400B with the setting range, it is possible to clearly determine whether the second condition is satisfied. Therefore, the completion of first adjustment S11 can be easily determined.

First adjustment step S11 may include determining the setting range based on an angle detected by angle sensor 400B and an installation height of radar 100. This makes it possible to determine an appropriate setting range according to the angle detected by angle sensor 400B and the installation height of radar 100.

The setting range may be determined by information terminal 500 configured to receive angle information indicating the angle detected by angle sensor 400B and height information indicating the installation height. Thus, the setting range can be easily determined by information terminal 500.

Angle check unit 400 may be attachable to and detachable from the radar. Angle check unit 400 may be attached to the radar in first adjustment S11. Accordingly, angle check unit 400 may be attached to radar 100 only when the first adjustment is performed.

Second adjustment step S21 may include determining whether the detection result of radar 100 satisfies the second condition set in advance. Second adjustment step S21 may be completed when the detection result of radar 100 satisfies the second condition. Accordingly, the execution entity (for example, the adjuster) of second adjustment S21 can easily determine the completion of second adjustment S21.

The second condition may be that the track of the vehicle detected by radar 100 is included in the lane. Accordingly, it is possible to clearly determine whether the second condition is satisfied based on the track of the vehicle detected by radar 100.

The second condition may be that a difference between the number of vehicles for each lane detected by radar 100 and the number of vehicles V for each lane in target area 300 is included in the predetermined setting range. Accordingly, it is possible to clearly determine whether the second condition is satisfied based on the number of vehicles for each lane detected by radar 1X).

[5. Appendix]

The embodiments disclosed herein are illustrative in all respects, and are not restrictive. The scope of the present invention is defined not by the above-described embodiments but by the claims, and includes all modifications within the scope and meaning equivalent to the claims.

### REFERENCE SIGNS LIST

100 radar
101 transmitting/receiving surface
102 radar body
103 depression angle adjustment unit
103a arm
103b coupling portion
104 horizontal angle adjustment unit
200 arm
300 target area
400 angle check unit
400A sighting device
400B angle sensor
400C smartphone
410 slit
420 fixing portion
500,600 information terminal
L lane boundary line
V vehicle
V1, V2 figure

1. A radar installation-angle adjustment method of adjusting an installation angle of an infrastructure radio-wave radar configured to detect an object in a target area, the method comprising:
first adjustment of adjusting an angle of a radar installed at an installation target without operating the radar; and
second adjustment of operating the radar the angle of which has been adjusted in the first adjustment, and adjusting the angle of the radar based on a detection result of the radar.

2. The radar installation-angle adjustment method according to claim 1, wherein
the first adjustment includes determining whether a check result of an angle check unit attached to the radar satisfies a first condition set in advance, and the first adjustment is completed when the check result satisfies the first condition.

3. The radar installation-angle adjustment method according to claim 2, wherein
the angle check unit is a sighting device, and
the first condition is that a field of view of the sighting device is included in the target area.

4. The radar installation-angle adjustment method according to claim 2, wherein
the angle check unit is an angle sensor configured to detect at least one angle of a horizontal angle and a depression angle of the radar, and
the first condition is that the angle detected by the angle sensor is included in a predetermined setting range.

5. The radar installation-angle adjustment method according to claim 4, wherein
the first adjustment includes determining the setting range based on the angle detected by the angle sensor and an installation height of the radar.

6. The radar installation-angle adjustment method according to claim 5, wherein
the setting range is determined by an information terminal configured to receive angle information indicating the angle detected by the angle sensor and height information indicating the installation height.

7. The radar installation-angle adjustment method according to claim 2, wherein
the angle check unit is attachable to and detachable from the radar, and
the angle check unit is attached to the radar in the first adjustment.

8. The radar installation-angle adjustment method according to claim 1, wherein
the second adjustment includes determining whether the detection result of the radar satisfies a second condition set in advance, and the second adjustment is completed when the detection result satisfies the second condition.

9. The radar installation-angle adjustment method according to claim 8, wherein
the second condition is that a position of an object detected by the radar is included in a predetermined range.

10. The radar installation-angle adjustment method according to claim 8, wherein
the second condition is that a difference between the number of objects detected by the radar and the number of objects in the target area is included in a predetermined setting range.
